(19) United States
(12) Patent Application Publication
(10) Pub. No.: US 2007/0279912 A1
(43) Pub. Date: Dec. 6, 2007

(54) Through-hull light

(76) Inventor: Peter Urquhart, Kent (GB)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/446,441

(22) Filed: Jun. 2, 2006

(51) Int. Cl. F21V 7/00

(52) U.S. Cl. 362/341

(57) ABSTRACT

An illumination apparatus which is, in the preferred embodiment, adapted to be mounted in a through-hull configuration in a marine vessel, and which is comprised of a housing, which is preferably cylindrically shaped, surrounding a light bulb and light bulb socket, or terminal block, a reflector, first adjustment structure for moving the light bulb and terminal block linearly relative to the reflector to adjust the sweep of emitted light, and second adjustment structure for altering the angular position of the light bulb, terminal block and reflector relative to the housing to adjust the angle of incidence of the emitted light.

### BACKGROUND OF THE INVENTION

1. Field of the Invention

This invention relates to illumination apparatus, and, more particularly, relates to a light fixture which allows for the angular and linear adjustment of the illumination element to vary the angle of incidence and sweep of light emitted from the device, respectively.

2. Background Art

There are many night time situations in which it is desirable to illuminate the water around a ship, boat or other surface vessel from the vessel itself. This is often done with powerful search lights mounted on the bridge, cabin, deck or other structure of the vessel that illuminate the upper surface of the water. However, in many cases a greater degree of illumination beneath the water surface is desired which can only be achieved if the light source is underwater. For example, divers can more safely enter the water from a vessel and climb out of the water into a vessel during the night if the area beneath the hull of the vessel near the jump point, swim step or ladder is illuminated. Night time search and rescue operations can also be facilitated by illuminating the water beneath its surface. Logs and other obstacles floating near the surface can be more easily identified and avoided during evening cruises with an underwater beam of light projecting from the bow of a vessel. Night time underwater photography is facilitated by illuminating the water beneath the surface adjacent the vessel hull. Fish and other sea life can also be attracted at night using underwater illumination. Aesthetically pleasing lighting effects can also be generated by projecting one or more beams of light laterally from the hull of a surface vessel beneath the water line so that they are readily visible to passengers and crew.

It is not practical to permanently attach underwater lights to the exterior of the hull due to the excessive drag that would be created, not to mention the severe mechanical strains on such appendages at high velocities of vessel travel. It is also tedious and cumbersome to lower lights on lines and cables from the deck of the vessel. Accordingly, thru-hull lights have been developed and used which essentially comprise a cylindrical lamp housing having a forward end with a protective, transparent, window that is mounted in water-tight fashion in a hole in the vessel hull with a conventional through hull fitting. The lamp is mounted in the housing behind the transparent window and is powered with shore power at the dock or the vessel's onboard power system when away from the dock. Numerous problems have been encountered with prior art thru-hull lights that have heretofore been commercialized for use with surface vessels, among them the problem of angle of incidence and sweep of their beam patters not being optimized.

Also, it is not possible to optimize the illumination of the water near a marine vessel in which an underwater thru-hull light is mounted for all boat types as the orientation of the vessel hull, e.g. transom, relative to vertical and horizontal planes varies significantly among vessel-types.

Numerous attempts have been made to provide submersible and/or through-hull lights having angularly adjustable bulb and reflector arrangements. For example, U.S. Pat. No. 5,672,004 to Schmidt, Jr., discloses a through-hull illumination apparatus having a reflector which is angularly adjustable relative to its position in the hull. However, the reflector is not adjustable from within the vessel, rendering adjustment thereof extremely difficult, as adjustment of the orientation of the reflector can only be performed by a person situated in or upon the water, exterior of the vessel. Also, providing means for adjusting the orientation of a submerged or submersible light risks breaching whatever watertight seal is associated with the light.

Also, attempts have been made at providing illumination apparatus having an illumination element (i.e. light bulb) which is movable relative to a reflector to permit adjustment of the emitted beam of light. For example, U.S. Pat. No. 5,128,845 to Hoffineier discloses a submersible electrical appliance which includes a housing having a water-tight function chamber separated by a bulkhead wall from a water-tight junction chamber, and means for moving a light bulb and fixture relative to a stationary reflector.

None of the art known to the inventor discloses a through-hull illumination apparatus which permits for the independent adjustment, by accessing the apparatus from within the vessel, of the cone of light emitted therefrom as well as the sweep, i.e. angle of incidence, of the light emitted therefrom.

It is, therefore, a principal object of this invention to provide an illumination apparatus which permits for the adjustment of the cone of light emitted therefrom, as well as the sweep, i.e. angle of incidence, of the light emitted therefrom.

It is also an object of this invention to provide a through-hull illumination apparatus for use under the water line of a marine vessel to adjustably and highly effectively illuminate the water adjacent the apparatus.

It is a further object of this invention to provide an improved illumination apparatus of the type described herein, which may be readily adapted to a variety of installations, including but not limited to installations involving marine vessels.

### SUMMARY OF THE INVENTION

These and other objects are achieved by the provision of an illumination apparatus which is, in the preferred embodiment, adapted to be mounted in a through-hull configuration in a marine vessel, and which is comprised of a housing, which is preferably cylindrically shaped, surrounding a light bulb and light bulb socket, or terminal block, a reflector, first adjustment structure for moving the light bulb and terminal block linearly relative to the reflector to adjust the sweep of emitted light, and second adjustment structure for altering the angular position of the light bulb, terminal block and reflector relative to the housing to adjust the angle of incidence of the emitted light.

The foregoing objects and features of the invention will be more readily understood from a consideration of the following detailed description, taken with the accompanying drawings, in which corresponding parts are indicated by corresponding numerals.

### BRIEF DESCRIPTION OF THE DRAWINGS

FIG. 1 is an exploded perspective view of the preferred embodiment of the invention.

FIG. 2 is a partially assembled cross-sectional elevational view of the apparatus shown in FIG. 1 showing the bulb and bulb socket in a fully retracted position.

FIG. 3 is a partially assembled cross-sectional elevational view of the apparatus of FIGS. 1 and 2 showing the bulb socket and bulb in a partially extended position.

FIG. 4 is a perspective view of a partially assembled lighting apparatus of the invention showing the bulb and bulb socket in the fully retracted position corresponding to FIG. 2.

FIG. 5 is a perspective view of the apparatus of FIG. 4 where the adjustment nuts 65a, 65b have been moved into the partially extended-position in anticipation of making a linear adjustment to the position of bulb 16 relative to reflector 18.

FIG. 6 is a perspective view of the apparatus of FIG. 4 showing the bulb and socket after being adjusted into the partially extended position corresponding to FIG. 3.

FIG. 7 is a cross-sectional elevational view of an assembled light in accordance with this invention.

FIG. 8 is a partially assembled cross sectional side elevational view of the apparatus of FIG. 7.

FIG. 9 is a side cross sectional elevational view of the apparatus of FIGS. 7-8 showing the second adjustment structure retaining the spherical ring (36), reflector, bulb and terminal block in a first angular adjustment position.

FIG. 10 is a side cross sectional elevational view of the apparatus of FIG. 7-9, showing the second adjustment structure loosened to permit angular adjustment of the spherical ring (36), reflector, bulb and terminal block into a second of an infinite number of angular adjustment positions.

FIG. 11 is a side elevational view of the apparatus shown in FIGS. 7-10 showing the second adjustment structure re-tightened to retain the spherical ring (36), reflector, bulb and mounting block in the second angular adjustment position.

### DESCRIPTION OF A PREFERRED EMBODIMENT

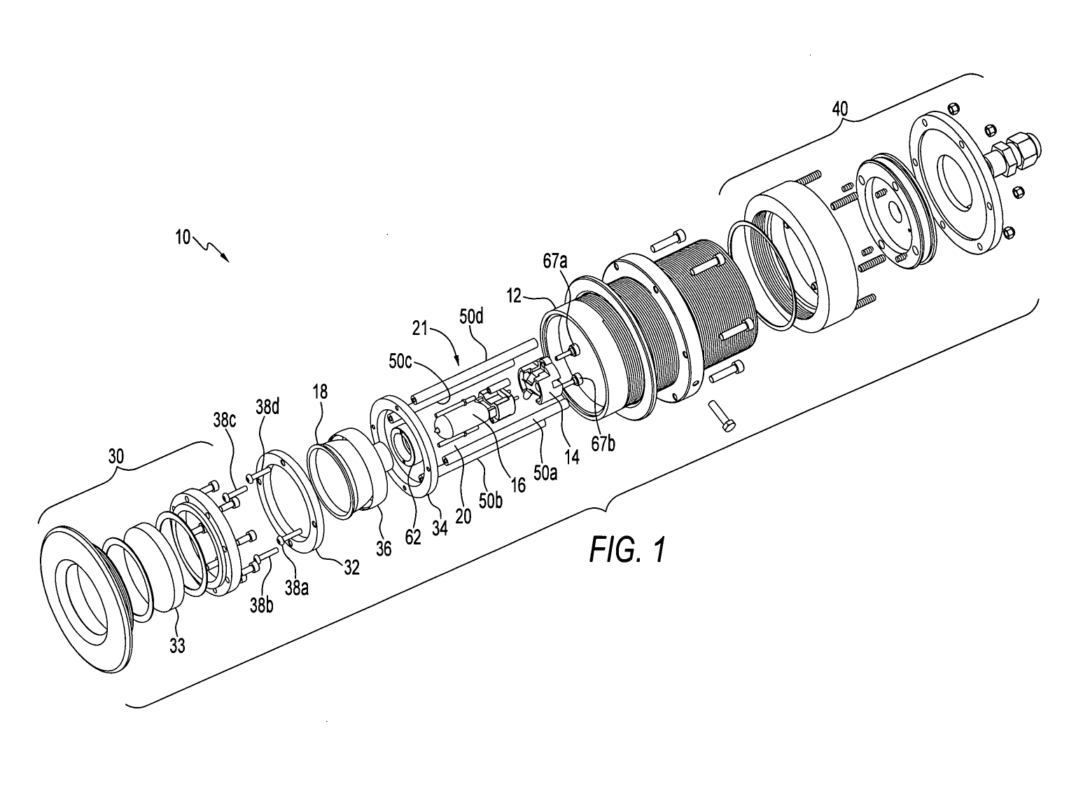

Referring now to the drawings, FIG. 1 shows, in exploded perspective, the preferred embodiment of the illumination device 10 of the invention which is comprised of a cylindrical housing or body member 12 surrounding a lamp bulb or lamp socket 14, a bulb or lamp fixture 16, spherical ring (36), a reflector 18, a first linear lamp adjustment apparatus 20, and a second, angular lamp adjustment structure 21, which will be described in more detail below.

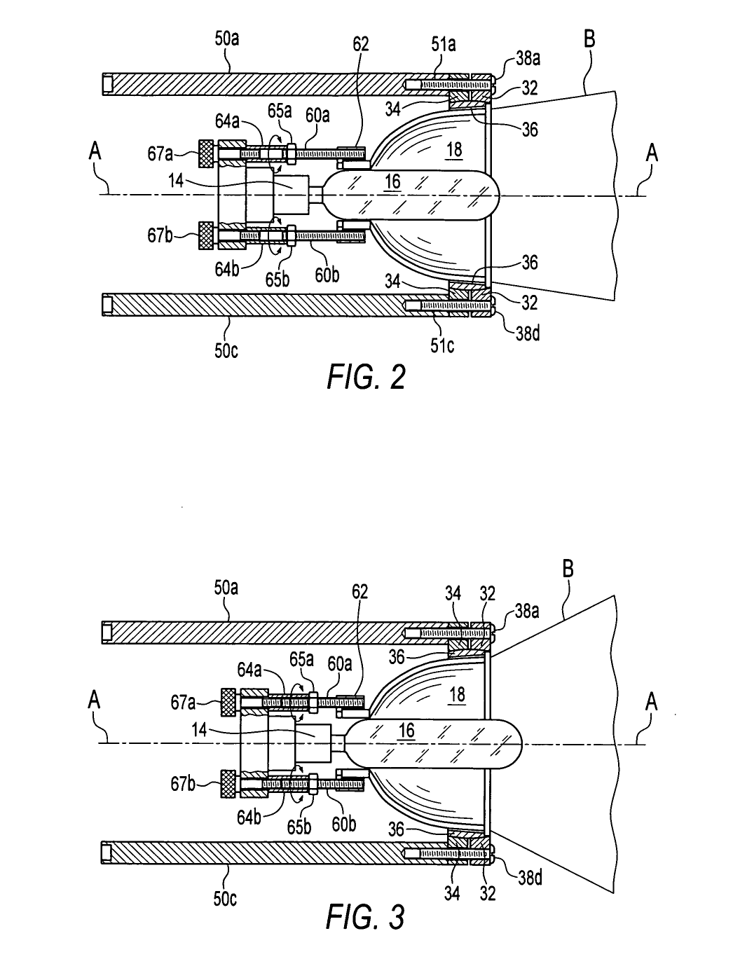

A front end closure assembly 30 is employed, which preferably includes a transparent lens 33 and which may be of any suitable configuration. Likewise, a rear removable closure assembly 40 is employed to cover the rear end of device 10. As seen in FIGS. 2 and 3, lamp 16 resides in substantially coaxial orientation relative to reflector 18, and is movable along axis A between a fully extended position (not shown) and a retracted position (shown in FIG. 3). FIG. 3 shows bulb 16 in a partially extended position. When bulb 16 is in the extended position, the beam of light B emitted from device 10 has a larger sweep, while the emitted beam of light B has a smaller sweep when the bulb 16 is in the retracted position. This is due to the change in the angle of incidence of the light emitted from the lamp arc or filaments of the bulb 16 upon the curved, e.g. parabolic, surface of reflector 18. It will occur to you those of skill in the art that any size, shape or power intensity of bulb 16 may be employed, the actual selection of which being a mere design choice.

Spherical ring (36) and reflector 18 (both parts are preferably rigidly fixed together) are held in angular position relative to housing 12 by upper and lower clamping discs 32, 34 respectively, which have outer surfaces shaped in accordance with a truncated sphere, and which sit in nesting engagement with a correspondingly shaped frustro-spherical ring 36 which is, a stated above, preferably rigidly connected to reflector 18. Clamping rings 32, 34 are placed in coaxial registry with one another and define a plurality of thru-holes through which fasteners, such as 38a, 38b, 38c and 38d, pass. Fasteners 38a-38d threadingly engage corresponding threaded journals within adjustment rods 50a, 50b, 50c and 50d.

The angular orientation of reflector 18, bulb 16 and lamp socket 14 can be adjusted to an infinite number of positions by unscrewing control rods 50a-50d, which causes clamping discs 32, 34 to tend to separate from one another, thereby relieving the frictional engagement between the inner facing spherical surfaces of clamping discs 32, 34, and the outer spherical surface of ring 36 in a manner to be more fully discussed below.

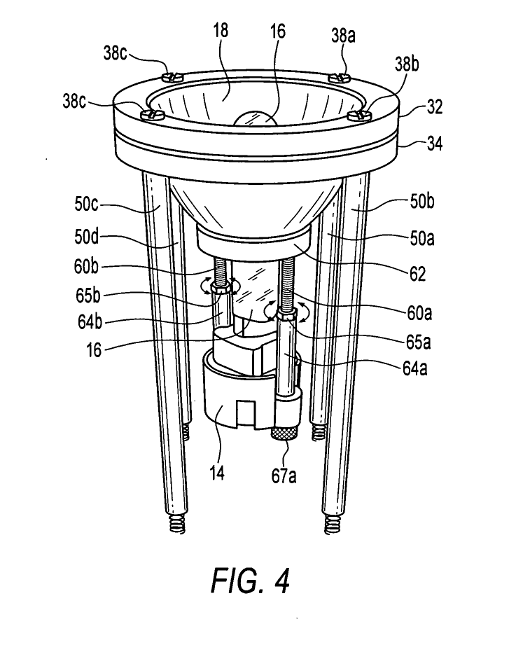

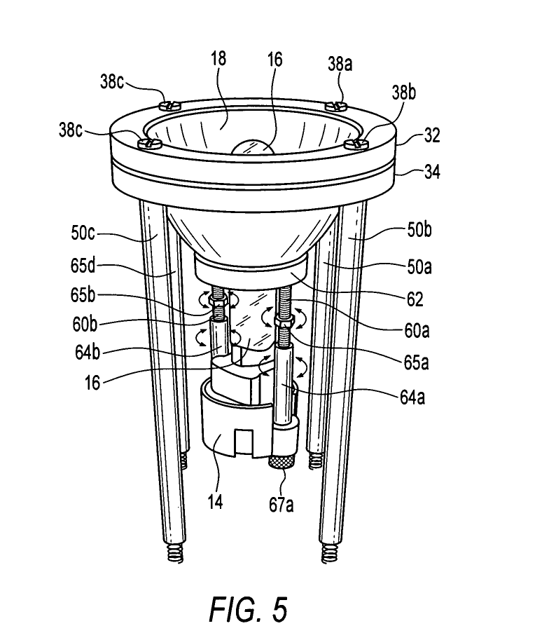

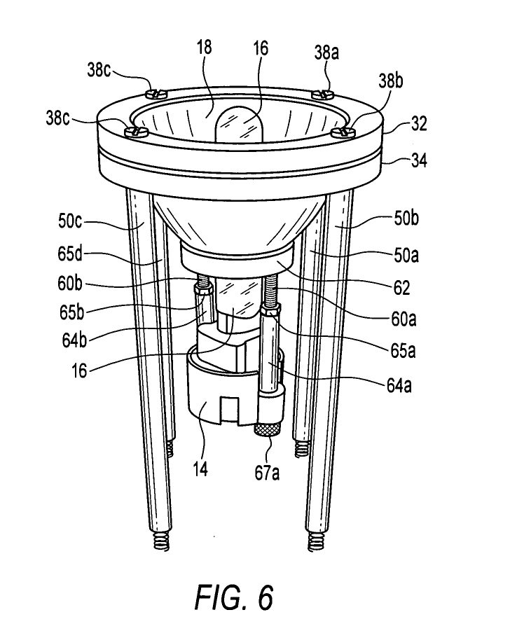

Referring again to FIGS. 2 through 6, it can be seen that the lamp socket 14 and bulb 16 are movable linearly with respect to reflector 18 via linear studs 60a, 60b, which are fixedly connected to reflector collar 62, which in turn is fixedly connected to reflector 18. Adjustment collars 64a, 64b and corresponding lock nuts 65a, 65b are threadingly engaged upon the studs 60a, 60b, respectively. In order to change the linear position of bulb and lamp socket 14 relative to reflector 18, lock nuts 65a, 65b and lamp holder securing screws 67a, 67b are loosened, permitting adjustment collars 64a, 64b to be threadingly rotated upon the studs, 60a, 60b, which in turn causes lamp socket 14 and bulb 16 to translate upon and move relative to the studs 60a, 60b. Therefore, to go from the partially extended position of bulb 16 and lamp socket 14 relative to reflector 18 shown in FIG. 2 to the fully retracted position of bulb 16 and lamp socket 14 relative to reflector 18 shown in FIG. 3, one would loosen lock nuts 65a, 65b, and lamp holder securing screws 67a, 67b rotate adjustment collars 64a, 64b clockwise when viewed looking down into reflector 18 from the right in FIG. 2, so as to cause lamp socket 14 and bulb 16 to move linearly to the left in FIG. 2 into the position shown in FIG. 3. Then, lock nuts 65a, 65b are likewise rotated clockwise when viewed looking down into reflector 18 from the right in FIG. 3 until they mate against the adjustment collars 64a, 64b, the lamp holder securing screws 67a, 67b are rotated anti-clockwise to abut the lamp holder 14 onto the adjustment collars 64a, 64b there by firmly clamping the lamp holder 14 into position.

In like manner, to linearly translate lamp socket 14 and bulb 16 relative to reflector 18 into the partially extended position shown in FIG. 2, one would rotate lock nuts 65a, 65b anti-clockwise when viewed looking down into reflector 18 from the right in FIGS. 2 and 3 until the desired position for lamp socket 14 and bulb 16 are reached, whereupon adjustment collars 64a, 64b are likewise rotated anti-clockwise until they abut the inboard surfaces (i.e. the left-side surfaces) of lock nuts 65a, 65b. By so doing, lamp socket 14 and bulb 16 are translated to the right in the Figures. If one were to rotate lock nuts 65a, 65b until they abut collar 62, and then rotate adjustment collars 64a, 64b until they abut the inboard surfaces of lock nuts 65a, 65b, the lamp socket 14 and bulb 16 would be in their fully extended positions (not shown). Likewise, by rotating lock nuts 65a, 65b counterclockwise a small amount when viewed from the right in FIG. 2, and rotating adjustment collars 64a, 64b counterclockwise along studs 60a, 60b until they push the left-side surface of the lamp socket 14 on to the lamp holder securing screws 67a, 67b and lamp 16 can be translated linearly relative to reflector 18 into a fully retracted position (not shown). It can readily be appreciated, therefore, that socket 14 and lamp 16 can be placed into any desired position of adjustment relative to reflector 18 between the fully retracted and fully extended positions so as to vary the sweep of beam of light B emitted from apparatus 10.

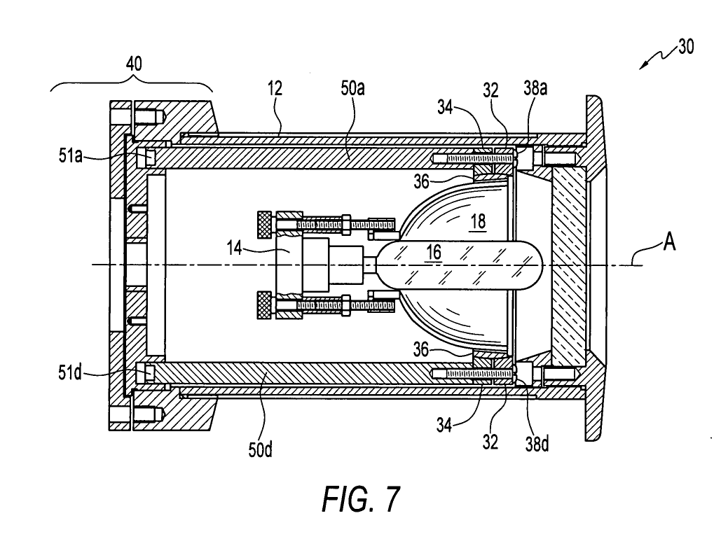

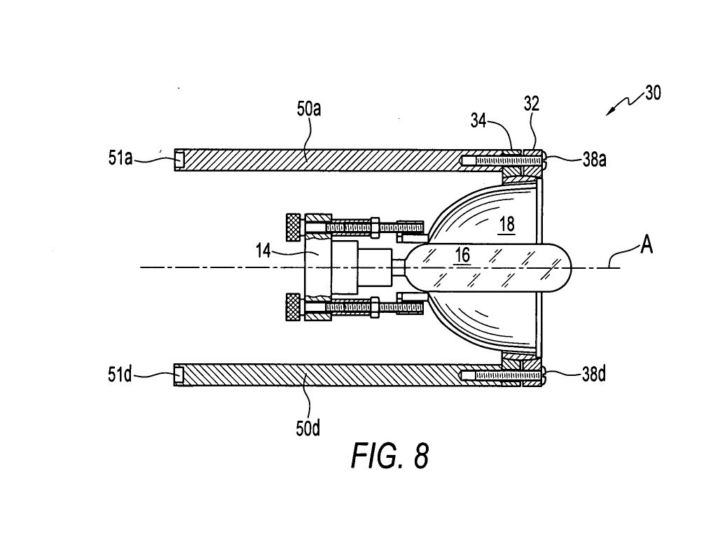

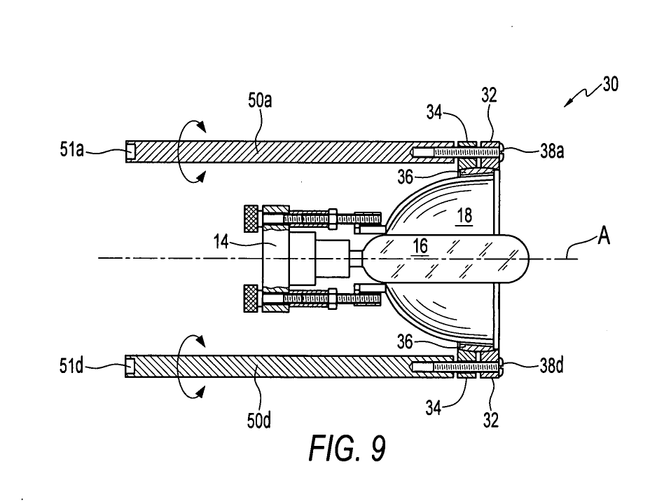

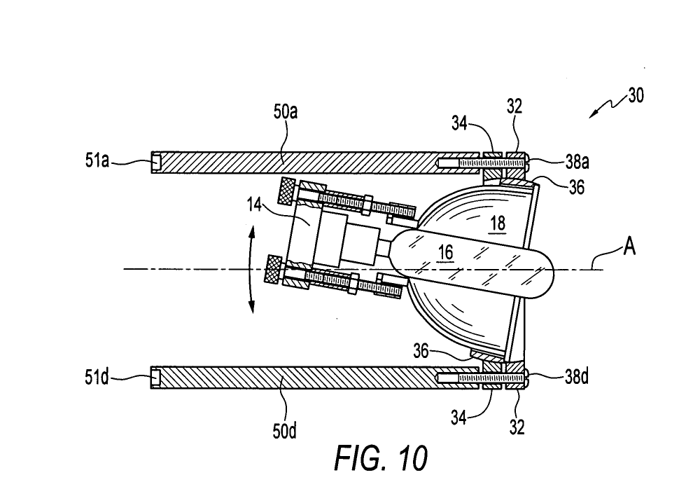

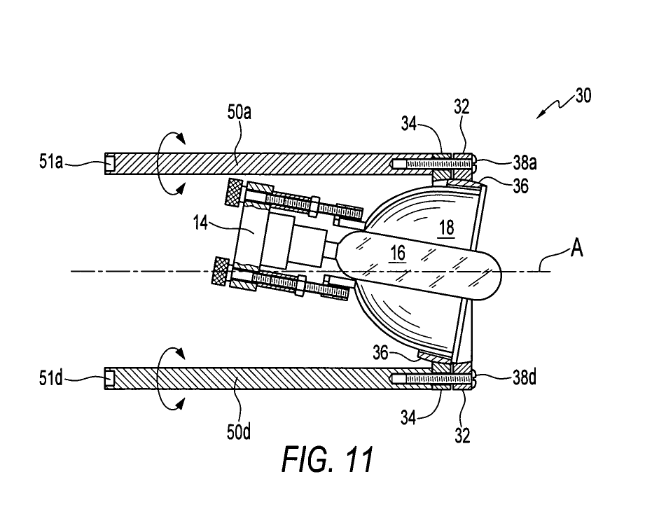

As shown in FIGS. 1 and 7 through 11, in order to adjust the angular orientation of lamp socket 14, bulb 16 and reflector 18, the four adjustment rods 50a-50d are rotated, as by engaging adjustment rod ends 51a-51d through the rear closure structure 40, which causes adjustment rod cap screws 38a-38d to begin to become threadingly disengaged from adjustment rods 50a-50d, which in turn causes clamping discs 32, 34 to move apart, which further in turn reduces the frictional engagement between the inner facing spherical surfaces of clamping discs 32, 34 with the outer spherical surface of ring 36. Then, lamp socket 14, bulb 16 and reflector 18 can be rotated into whatever angular position is desired, and adjustment rods 50a-50d are simply rotated in the opposite direction, as by engaging ends 51a-51d thereof, causing adjustment rods 50a-50d to become threadingly tightened upon cap screws 38a-38d, which in turn causes discs 32, 34 to be moved together. This, then, causes a frictional engagement with ring 36, such that reflector 18 is then locked into position relative to housing 12.

It is to be understood that, although the preferred embodiment of the apparatus 10 is a submersible, through-hull, illumination device, the device need not be submersible to operate in accordance with the principles of the invention. In the case of a submersible apparatus 10, or one that will otherwise be exposed to or susceptible or exposure to water should employ watertight closure assemblies 30 and 40.

1. An illumination device adapted to be mounted through the hull of a marine vessel below a waterline, the illumination device including a housing, a light source, a light source socket, a reflector concentrically positioned about the light source, a linear adjustment structure and angular adjustment structure, the linear adjustment structures comprising:
one or more adjustment studs connecting the light source socket and light source to the reflector such that the light source can be adjusted linearly relative to the reflector between a first, fully retracted, position and a second, fully extended, position, or anywhere in between;
the angular adjustment structure comprising:
at least one clamping disc connected to the housing adapted to adjustably retain the reflector, light source and light source socket in any one of an infinite number of angular adjustment positions relative to the housing.

2. The device of claim 1, further comprising one or more control rods releaseably connected to the at least one clamping disc to permit clamping and unclamping engagement between the at least on clamping disc and the reflector.

3. The device of claim 2, further comprising a spherical ring rigidly connected to the reflector and adapted to be squeezingly engaged by the clamping disc to retain the reflector, light source and light source socket in a particular angular adjustment position relative to the housing.
